(19) United States
(12) Patent Application Publication
(10) Pub. No.: US 2018/0102689 A1
(43) Pub. Date: Apr. 12, 2018

(54) TRAFFIC BARRIER WITH INTEGRATED TURBINE

(71) Applicant: International Business Machines Corporation, Armonk, NY (US)

(72) Inventor: Marco Antonio Martinez Ruvalcaba, Zapopan (MX)

(21) Appl. No.: 15/290,072

(22) Filed: Oct. 11, 2016

(51) Int. Cl. H02K 7/18; F03D 13/00; E01F 15/08; F03D 9/46

(52) U.S. Cl. CPC H02K 7/183; F03D 9/46; E01F 15/08; F03D 13/00

(57) ABSTRACT

An energy harvesting system includes a barrier disposed adjacent to a first traffic lane, the barrier comprising an aperture and a turbine disposed within the aperture. The turbine may be configured to generate electrical power in response to airflow through the aperture and in response to horizontal airflow that is tangential to the barrier and the aperture. In some embodiments, the barrier is disposed between the first traffic lane and a second traffic lane and may function as a traffic median. Consequently, the first traffic lane and the second traffic lane are may be counter-flowing traffic lanes. A method and apparatus corresponding to the above system are also disclosed herein.

### BACKGROUND OF THE INVENTION

The present invention relates generally to harvesting energy and more particularly to harvesting airflow energy associated with vehicular traffic.

Vehicular traffic generates significant airflow particularly on highways and freeways where traffic flows at high speeds.

### SUMMARY

An energy harvesting system includes a barrier disposed adjacent to a first traffic lane, the barrier comprising an aperture and a turbine disposed within the aperture. The turbine may be configured to generate electrical power in response to airflow through the aperture and in response to horizontal airflow that is tangential to the barrier and the aperture. In some embodiments, the barrier is disposed between the first traffic lane and a second traffic lane and may function as a traffic median. Consequently, the first traffic lane and the second traffic lane are may be counter-flowing traffic lanes. A method and apparatus corresponding to the above system are also disclosed herein.

### BRIEF DESCRIPTION OF THE DRAWINGS

FIGS. 1A, 1B, and 1C are respective side, end, and top view illustrations depicting one example of a traffic barrier in accordance with at least one embodiment disclosed herein;

FIG. 1D is an cross-sectional view illustration depicting one example of an installed traffic barrier in accordance with at least one embodiment disclosed herein;

FIG. 2A is a front view illustration depicting one example of a turbine in accordance with at least one embodiment disclosed herein;

FIG. 2B is a top view illustration depicting one example of a turbine in accordance with at least one embodiment disclosed herein;

FIG. 3 is a top view illustration depicting one example of a traffic barrier system in accordance with at least one embodiment disclosed herein; and

FIG. 4 is a block diagram and a cross-sectional view illustration depicting one example of components associated with an installed traffic barrier system.

### DETAILED DESCRIPTION

One or more of embodiments disclosed herein recognize that vehicular traffic produces significant proximal airflow. One or more of embodiments disclosed herein recognize that the airflow from counter-flowing traffic can be harvested with vertical axis turbines.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment disclosed herein. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. These features and advantages will become more fully apparent from the following drawings, description and appended claims, or may be learned by the practice of the invention as set forth hereinafter.

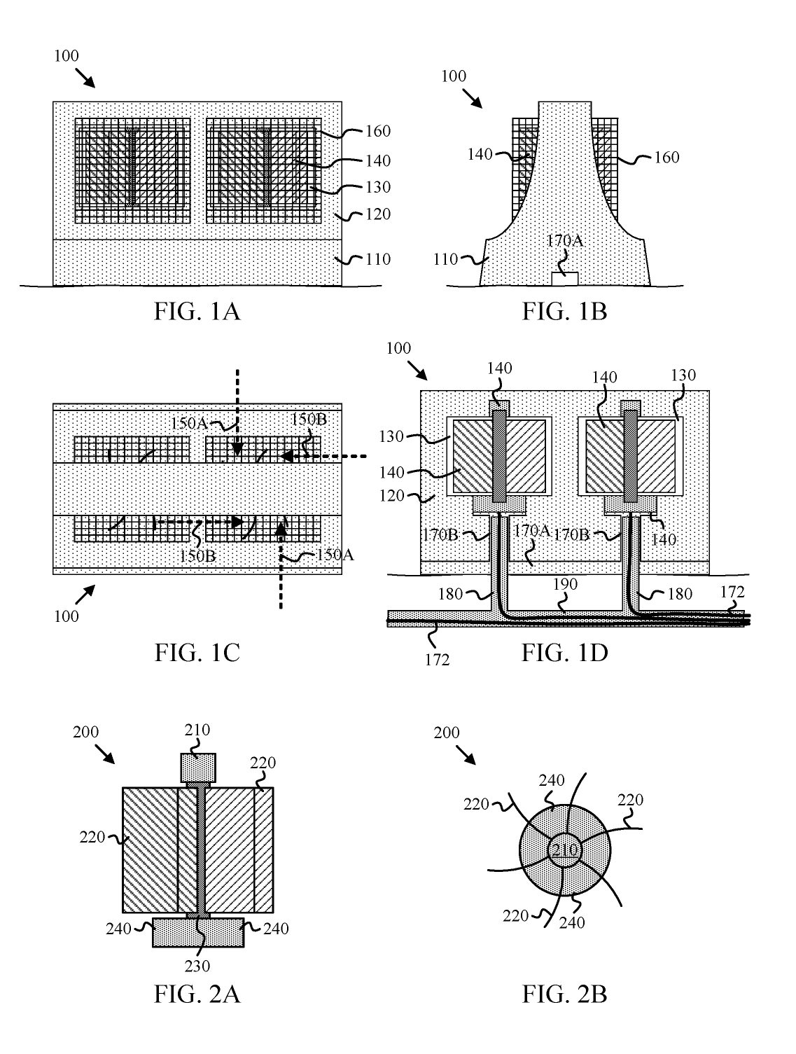

FIGS. 1A, 1B, and 1C are respective side, end, and top view illustrations and FIG. 1D is an cross-sectional view illustration depicting one example of a traffic barrier 100 in accordance with at least one embodiment disclosed herein. As depicted, the traffic barrier 100 includes a base 110, a body 120, and one or more apertures 130. The traffic barrier 100 may be deployed between and/or adjacent to traffic lanes and used to harvest airflow energy including airflow energy caused by the flow of traffic.

The traffic barrier 100 may be a movable barrier. The base 110 may be thicker than the body 120 in order to add stability to the traffic barrier 100. In the depicted embodiment, a turbine 140 is disposed within each aperture 130 that is configured to generate electrical power in response to airflow 150A through the aperture. The depicted apertures are rectangular in shape. The turbines 140 may also be configured to generate electrical power in response to airflow 150B that is horizontally tangential to the aperture 130 and the barrier 100 as a whole. See FIG. 2 and the associated description for additional details on one example of the turbine 140.

In the depicted embodiment, a protective grid 160 covers each aperture 130 and the turbines 140 disposed therein. The protective grid 160 may protect the turbine 140 from damage while allowing airflow through the apertures 130 and tangential to the apertures 130 and the barrier 100 as a whole.

The depicted traffic barrier 100 also has a horizontal feed channel 170A and two vertical feed channels 170B. The feed channels 170A and 170B enable wiring 172 to be distributed to, and connected to, the turbines 140 (wiring is not shown in the depicted feed channel 170A). In the depicted embodiment, the vertical feed channels 170B are centrally disposed in the lower wall (i.e., shelf) of each aperture 130.

FIG. 1D also shows that each vertical feed channel 170B may mate with a feed pipe 180. The feed pipes 180 may extend into the ground and laterally secure the barrier 100 in place. The depicted feed pipes 180 are connected to an access pipe 190 that enables connecting wiring to multiple turbines 140 via corresponding feed pipes 180.

FIG. 2A is a front view illustration and FIG. 2B is a top view illustration depicting one example of a turbine 200 in accordance with at least one embodiment disclosed herein. As depicted, the turbine 200 includes a bearing 210, a number of blades 220, a shaft 230, and a generator 240. The turbine 200 may harvest energy from airflow.

The depicted turbine 200 is a vertical axis turbine that harvests energy from airflow that comprises a horizontal component (i.e., non-vertical airflow) regardless of the direction of the horizontal component. In particular, the depicted turbine 200 is a Savonius type split-blade turbine.

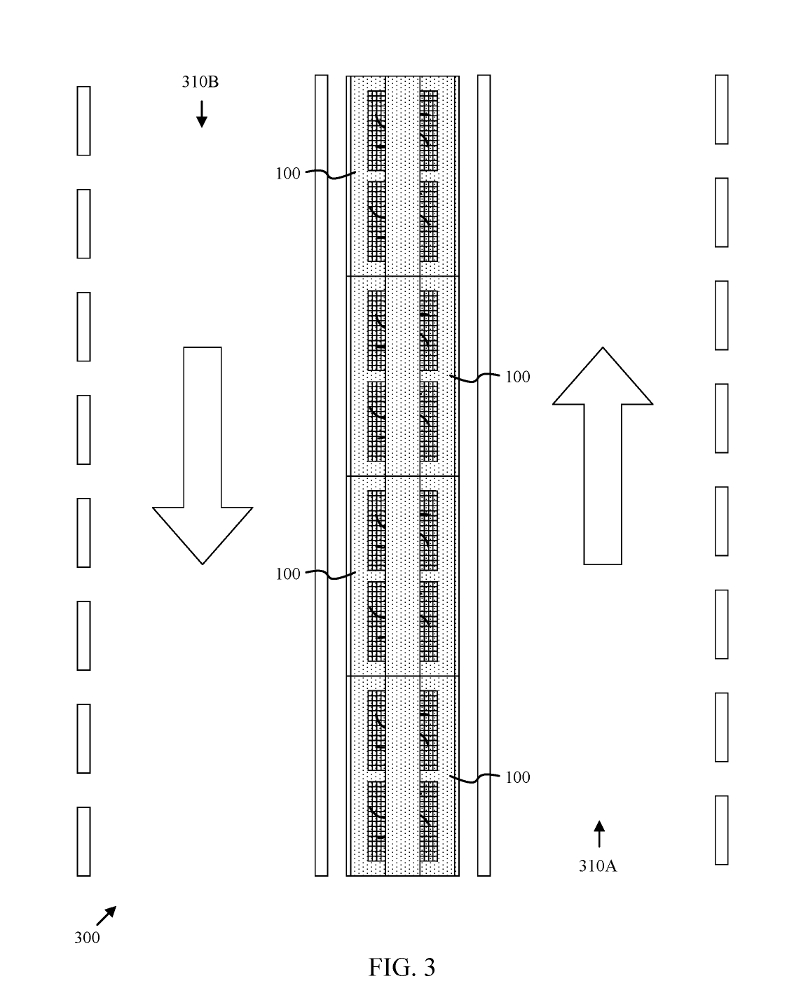

FIG. 3 is a top view illustration depicting one example of a traffic barrier system 300 in accordance with at least one embodiment disclosed herein. The traffic barrier system 300 includes a number of traffic barriers 100 that are disposed as a median between two counter-flowing traffic lanes 310, namely, a northbound lane 310A and a southbound lane 310B. Traffic on the counter-flowing lanes may, in general, generate northbound airflow in the northbound lane 310A and southbound airflow in the southbound lane 310B. The orientation of the turbines disposed within the traffic barriers 100 may facilitate efficient harvesting of energy from northbound airflow in the northbound lane 310A and southbound airflow in the southbound lane 310B. Furthermore, eastbound airflow and westbound airflow from either lane may also be harvested due to the orientation of, and type of, turbines within the traffic barriers 100. For example, by using vertical axis turbines, energy may be harvested from any airflow with a horizontal component.

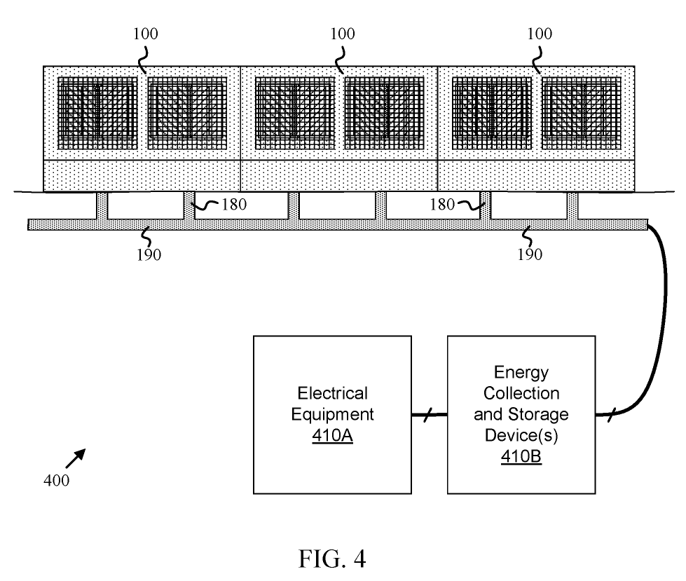

FIG. 4 is a block diagram and a cross-sectional view illustration depicting one example of components 410 associated with an installed traffic barrier system 400. As depicted, the installed traffic barrier system 400 includes electrical equipment 410A and one or more energy collection and storage devices 410B. In addition, other components may be electrically connected to the installed traffic barrier system 400 such as street lights, traffic lights, traffic monitoring and control devices, communications equipment, and the like.

As implied in FIG. 4, the energy collection and storage devices 410B may be connected in parallel to multiple turbines disposed in the barriers 110 and capture at least a portion of the electrical power generated by those turbines. The energy collection and storage devices 410B may also provide (local/remote) power during periods of reduced traffic or wind and/or high electrical demand. In some embodiments, the components 410 are also (fully or intermittently) connected to an electric utility as a backup source of power. In one embodiment, the energy collection and storage devices 410B collect energy from the electric utility when the locally stored energy is depleted below a selected level and the power provided by the turbines is insufficient to replenish the locally stored energy.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An energy harvesting system comprising:
a unitary traffic barrier disposed adjacent to a first traffic lane, the unitary traffic barrier comprising a plurality of apertures than enable airflow through the unitary traffic barrier that is perpendicular to a length of the unitary traffic barrier; and
a turbine disposed within each aperture of the plurality of apertures such that each turbine is integrated into and encompassed by the unitary traffic barrier, each turbine configured to generate electrical power in response to airflow through the aperture corresponding to the turbine and in response to horizontal airflow that is tangential to the unitary traffic barrier and the aperture corresponding to the turbine.

2. The system of claim 1, wherein the unitary traffic barrier is disposed between the first traffic lane and a second traffic lane.

3. The system of claim 2, wherein the first traffic lane and the second traffic lane are counter-flowing traffic lanes.

4. The system of claim 1, wherein the unitary traffic barrier is movable.

5. The system of claim 1, wherein a base of the unitary traffic barrier is thicker than a top of the unitary traffic barrier.

6. The system of claim 1, wherein the aperture is rectangular.

7. The system of claim 1, wherein the turbine is a vertical axis turbine.

8. The system of claim 7, wherein the turbine is a Savonius turbine.

9. The system of claim 8, wherein the turbine is a split-blade turbine.

10. The system of claim 1, further comprising a protective grid configured to cover the aperture and the turbine.

11. The system of claim 1, further comprising a battery storage device configured to capture at least a portion of the electrical power.

12. The system of claim 1, further comprising electrical equipment configured to consume at least a portion of the electrical power.

13. The system of claim 1, at least one feed channel for connecting wires to the turbine.

14. The system of claim 13, wherein a feed channel of the at least one feed channel is configured to receive a feed pipe.

15. The system of claim 14, wherein the feed pipe extends into the ground and laterally secures the unitary traffic barrier.

16. An energy harvesting method comprising:
placing a unitary traffic barrier adjacent to a first traffic lane, the unitary traffic barrier comprising a plurality of apertures than enable airflow through the unitary traffic barrier that is perpendicular to a length of the unitary traffic barrier;
wherein each aperture of the plurality of apertures has a turbine dispose therein such that each turbine is integrated into and encompassed by the unitary traffic barrier, each turbine configured to generate electrical power in response to airflow through the aperture corresponding to the turbine and in response to horizontal airflow that is tangential to the unitary traffic barrier and the aperture corresponding to the turbine.

17. The method of claim 16, wherein the unitary traffic barrier is disposed between the first traffic lane and a second traffic lane.

18. The method of claim 17, wherein the first traffic lane and the second traffic lane are counter-flowing traffic lanes.

19. The method of claim 16, further comprising powering electrical equipment proximate to the unitary traffic barrier.

20. An energy harvesting apparatus comprising:
a unitary traffic barrier comprising a plurality of apertures than enable airflow through the unitary traffic barrier that is perpendicular to a length of the unitary traffic barrier; and
a turbine disposed within each aperture of the plurality of apertures such that each turbine is integrated into and encompassed by the unitary traffic barrier, each turbine configured to generate electrical power in response to airflow through the aperture corresponding to the turbine and in response to horizontal airflow that is tangential to the unitary traffic barrier and the aperture corresponding to the turbine.
